(19) United States
(12) Patent Application Publication
(10) Pub. No.: US 2020/0356924 A1
(43) Pub. Date: Nov. 12, 2020

(54) SYSTEM AND METHOD FOR DETERMINING OPTIMAL REGIONS FOR APPLICATION OF GEOSPATIAL STRATEGIES

(71) Applicant: Capital One Services, LLC, McLean, VA (US)

(72) Inventor: Steve FRENSCH, Kitchener (CA)

(73) Assignee: Capital One Services, LLC, McLean, VA (US)

(21) Appl. No.: 16/406,917

(22) Filed: May 8, 2019

(51) Int. Cl. G06Q 10/06; G06F 16/29

(52) U.S. Cl. CPC G06Q 10/0637; G06Q 10/0635; G06F 16/29

(57) ABSTRACT

Various embodiments are directed to techniques for defining and optimizing the boundaries of geospatial areas predictive of various outcomes. A geographic area of interest is defined, and a model trained to predict the variable of interest within the geographic area of interest is trained using training data selected for the geographic area. The model is scored for each cell in a meshed grid defined over the geographic area of interest and, thereafter, a contour-finding algorithm is applied to the grid to define the optimized geographic area.

### BACKGROUND

A high rate of occurrence of a particular event involving people living or working within a geographic area may be predictive that the same event will occur involving other people living or working within the geographic area. For example, in the financial services industry, a high percentage of late credit card payments from people living within a particular geographic area may be indicative that others living in that area are also likely to engage in late credit card payments. Such predictive outcomes may be dependent solely on geographic location or may be dependent on geographic location in combination with other variables. For example, a geographic area having a high percentage of people having late credit card payments and low FICO scores may be predictive of the likelihood that a person living in that area will default on their credit card.

A geospatial strategy may be defined and implemented based upon the predicted outcomes. For example, in a geographic area having a high percentage of people having late credit card payments, higher interest rates may be charged to all customers living in that area for the use of the credit cards, even for those having no history of late payments. It is thus important to find the optimal region for application of the geospatial strategy, so as to balance the risk to the financial institution with the cost to the customer.

The definition of the geographic area may be problematic. Geographic areas defined by artificial political or geographic boundaries, for example, by the boundaries of a state, county, town or ZIP Code, are often not granular enough to achieve the goals of the geospatial strategy. A particular town or ZIP Code area, for example, may have both affluent areas and financially depressed areas within its boundaries. Likewise, a financially depressed area may extend over the boundaries of several towns or ZIP Code areas. Therefore, would be desirable to be able to optimize the boundaries of geospatial areas predictive of various outcomes and independent of artificial boundaries.

### BRIEF DESCRIPTION OF THE DRAWINGS

FIG. 1 shows the desired outcome of the system and method of the present invention.

FIG. 2 is a diagram showing a meshed grid overlaid on a geographic area of interest.

FIG. 3 is a block diagram of the geospatial boundary optimization system.

FIG. 4 is a diagram showing the optimized geographic area derived from the overlaid mesh grid of FIG. 3.

FIG. 5 is a flow chart of the method according to the present invention.

FIG. 6. is an example of the use of the method of the claimed embodiments.

FIG. 7 is a block diagram of a computing platform which may be used to implement the claimed embodiments.

### DETAILED DESCRIPTION

Various embodiments are directed to techniques for defining and optimizing the boundaries of geospatial areas predictive of various outcomes. In one embodiment, datasets containing event tuples having a variable of interest (i.e. credit scores, delinquencies, etc.) and a geographic location are collected. A machine-trained model may be built which predicts the variable of interest using the geographic location as an input. The machine-trained model may be trained using the datasets containing the event tuples. A meshed grid of latitude-longitude points may be defined overlaid on a geographic area of interest and scores for each cell in the grid are computed using the machine-trained model. Thereafter, an edge-finding algorithm is applied to the scored grid to define the logical boundaries of various values for the variable of interest to define an optimal geographic area. Geospatial strategies may then be implemented based upon the inclusion or exclusion of people within the boundaries of the optimized geographic area.

A prior art method of performing the geographical area definition utilizes artificial boundaries, for example state, county, city or ZIP code boundaries. In an example using state boundaries, because the artificial boundaries are so large, the rate of a bad outcome can only be determined for each state. As a result, the application of a geospatial strategy will apply to everyone within the artificial boundaries, in this case, everyone within the boundaries of each state, which may be an undesirable outcome.

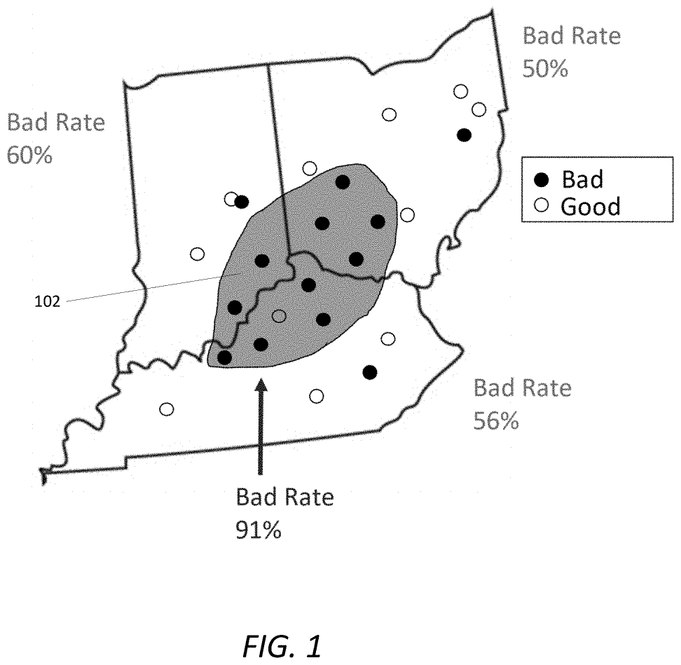

FIG. 1 shows the desired outcome of an optimized geographic area wherein the geographic area shown as shaded area 102 in FIG. 1 has been defined as the area showing a high concentration of the bad outcome, in this case a bad outcome rate of 91%. This result is much more useful than the bad outcome rates shown for the individual states, which would be obtained when using state boundaries define the geographic area of interest.

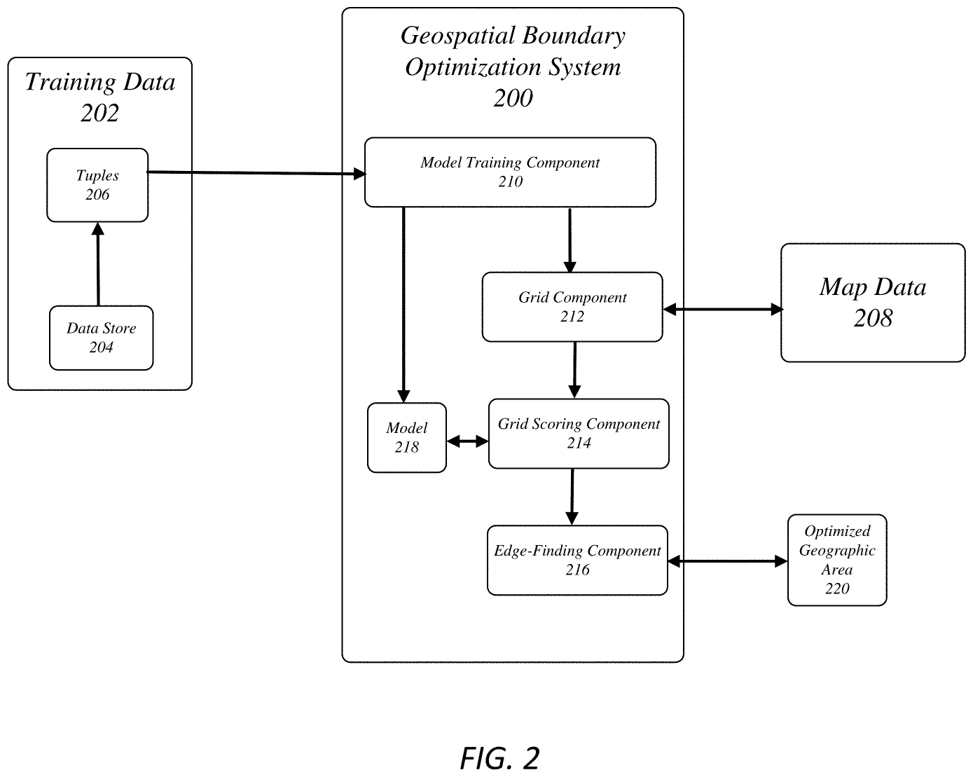

FIG. 2 is a block diagram of us of a geospatial boundary optimization system 200 in accordance with various embodiments of the present invention. Model training component 210 is used to train model 218. Training the model may require a population of events with a “target variable” which could be either continuous (numeric) or categorical (discrete category), along with the geographic location of the event. The geographic location may be expressed as a latitude/longitude pair, but any means of expressing a location may be used, for example, a street address. Preferably, the events selected for training of the model will be limited to a geographic area of interest, such that the model can be used to predict the variable of interest for the geographic area for which it was trained. An “event” may or may not be a discrete event. An “event” may also describe a condition, such as a low FICO score.

A data source for the training data 202 may be any source of data regarding outcome variables associated with geographic locations. In some embodiments, the training data may be collected from either proprietary or public data related to the events of interest, so long as each data point is associated with a geographic location, and the variable of interest. For example, in the case of a financial institution, the data store 204 may contain records for each customer indicating, for example, the address of each customer (i.e. geographic location), a payment history for each customer or change in FICO score for each customer (events). Many other data points for each customer are possible.

Data may be selectively extracted from data store 204 and formed into tuples 206 for use by model training component 210 to train model 218 to predict a specific variable of interest. The tuples may comprise, in one embodiment, the data for a single customer, for example, a variable of interest and a geographic location associated with the variable of interest. In other embodiments, tuples may comprise a variable of interest and other data variables as well as a geographic location. As an example, in the case of a financial institution, the variable of interest may be customers having a certain number of late credit card payments, and a FICO score at a certain level may be indicative of this variable of interest. In such a case, the tuples would comprise the variable of interest, the FICO score and the geographic location.

Model training component 210 takes training data 202 in the form of tuples 206 to be used to train model 218. Model 218 will be trained such that an input of a geographic location results in an output indicating the variable of interest. The output may be, in some embodiments, in the form of a probability or may be, in other embodiments, a binary value. Model 218 may use any well-known type of machine-learning model, for example, a neural network, random forests, gradient boosting machines or scalable vector machines. The claimed embodiments are not meant to be limited to the enumerated methods. Any known method of training the models may be used. In some embodiments, the collected dataset comprising the training data may be split into testing and training datasets to ensure the robustness and stability of the model, with the model being trained on the training portion of the dataset, and tested on the testing portion of the dataset.

Grid component 212 is used to define a grid over the geographic area of interest. Model training component 210 may provide grid component 212 with an indication of the geographic area of interest based upon the geographic locations associated with each tuple in the training data.

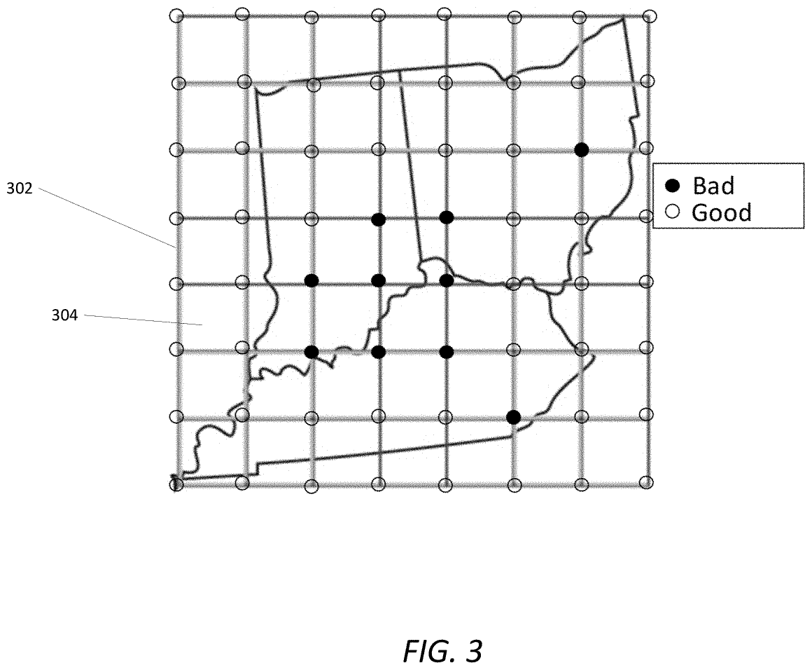

FIG. 3 shows an example of a grid 302 defining a plurality of cells 304 overlaid on a geographic area comprising the states of Kentucky, Indiana and Ohio. In some embodiments, the resolution of the grid may be finer or coarser than shown in FIG. 3. In some embodiments, the geographic area may be smaller or larger than shown in FIG. 3. In any case, the resolution of the grid 302, as well as the geographic area on which the grid is overlaid may be dependent upon the training data selected to train model 218. For example, it makes no sense to select a geographic area comprising Kentucky, Indiana and Ohio on which to overlay the grid 302 when the training data used to train model 218 is selected from customers living in California. Grid component 212 may utilize map data 208 to select the geographic area of interest. In a preferred embodiment, the cells 304 of grid 302 may be square in shape, however, in other embodiments, cells 304 of any regular shape may be used.

Grid scoring component 214 uses model 218 to generate a score for the variable of interest for each cell within the grid. Because the model uses a geographic location as input, a geographic location for each cell in the grid must be determined. There are several methods that may be used. In one embodiment, the geographic center of each grid may be used as the geographic location of the grid, and the resulting scoring of the model for the variable of interest at the center of the grid may be applied to the whole cell. In other embodiments, a score for each corner of each cell may be obtained based on the geographic location of the corners. In such a case, the score for the cell may be, for example, the average of the scores for each corner of the cell. In yet another embodiment, the scores for the grid intersection points could be used. FIG. 3 shows the latter example, in which the grid intersection points are used as the score for the variable of interest in each cell.

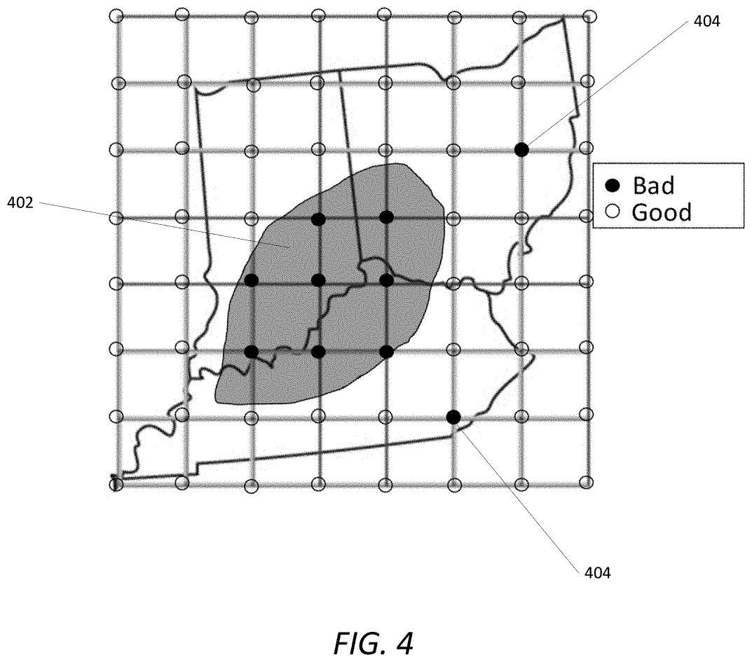

Once scores for each cell have been calculated by model 218, edge finding component 216 defines the boundary of the optimized geographic area. A contour finding algorithm (for example, a contour finding algorithm used in image processing) may be used two delineated the differences in outcome. The claimed embodiments are not limited to a specific contour finding algorithm. Any well-known contour-defining or edge-finding algorithm may be used. FIG. 4 shows an example of the result of the contour finding algorithm. The shaded area 402 in FIG. 4 represents a bad outcome for the variable of interest. Preferably, shaded area 402 excludes outlying points 404. Shaded area 402 in FIG. 4 represents the optimized geographic area 102, shown in FIG. 1. The optimized graphic area may be expressed as a series of vectors or a latitude/longitude path. The path values may then be used to score new events by determining if those events are inside or outside of the boundaries of optimized geographic area 220. Algorithms are well known for making this determination, for example, algorithms used in geofencing may be applied. As an example, a new customer may reside within an optimized geographic area indicating a high risk of loan default. The new customer may be subject to a policy charging a higher interest rate for those living within the optimized geographic area, regardless of the customer's actual individual history.

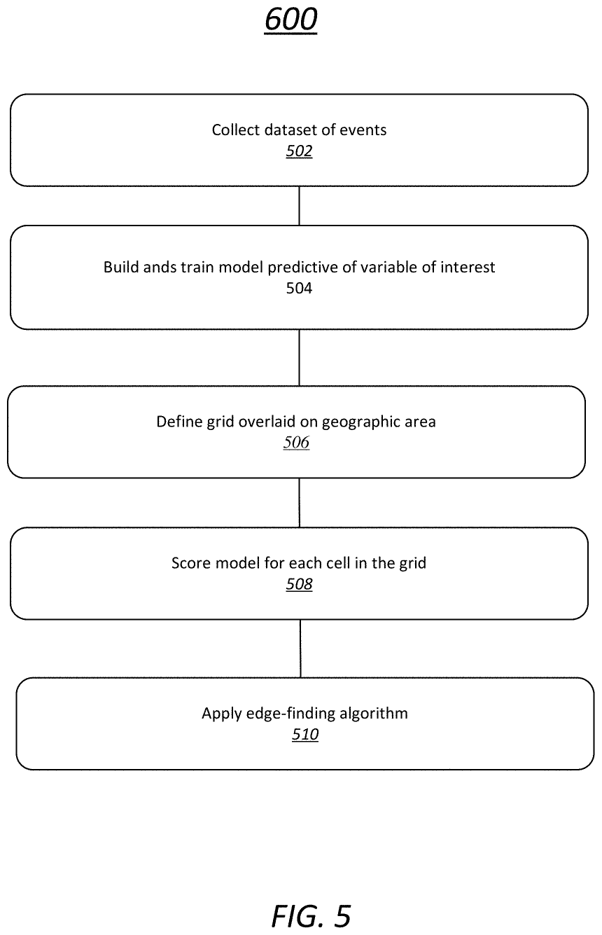

FIG. 5 is a flow diagram showing the method implemented by the system of FIG. 2. At 502, the data set of events is collected from a data store 204. The data set may be in the form of tuples 206 associating each data point with a geographic location. The tuples 206 should be selected from the data store 204 to include only events occurring within a defined geographic area of interest. At 504, the machine learning model is built by model training component 210 and trained using the collected dataset. Preferably, the model is predictive of the variable of interest, given an input of geographic location. At 506, a grid is defined and overlaid on the geographic area by grid component three twelve. The geographic area should correspond to the geographic area used to select the training data for the machine learning model. The resolution of the grid should also be selected depending upon the density or sparsity of the data in the dataset. For example, it makes no sense to select a grid resolution resulting in a grid having cells smaller than a single data point. At 508, the model is used to provide a score for each cell in the grid by grid scoring component 214. The scores are predictive of the value of the variable of interest and may be, for example, a probability or binary value. At 510, and edge finding algorithm is applied by edge finding component 216 to define a contour comprising the boundary of the geographic area optimized for the variable of interest.

Once the optimized geographic area 220 is defined, a geospatial strategy may be applied for all customers within the geographic area. For example, if the output variable of interest from the model for the geographic area represents a risk of default on a loan or credit card, a higher interest rate could be applied to all customers within the optimized geographic area 220. In other embodiments, the optimized geographic areas 320 could be used for marketing purposes. For example, if a geographic area is defined to determine concentrations of people having high FICO scores, enhanced credit cards could be marketed to people living within that geographic area. The optimized geographic area 220 is considered optimized based upon its non-dependence on artificial political or geographic boundaries.

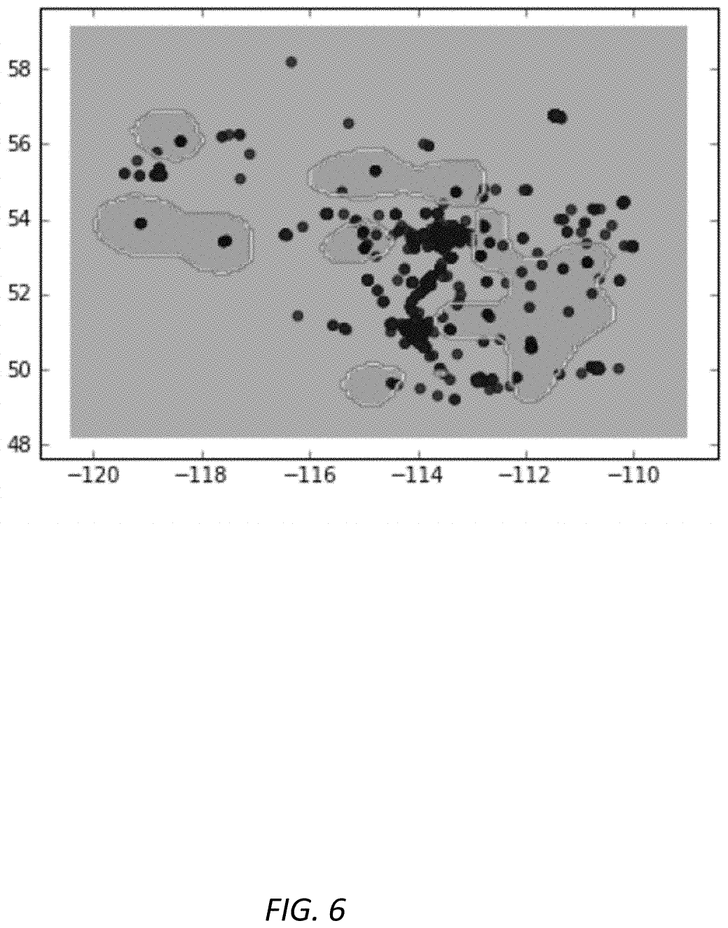

FIG. 6 shows an example of the use of the claimed embodiments. The variable of interest for this use was low FICO scores, shown in FIG. 6 as the dots within the gray outlines. The dots within the gray outlines represent instances of customers having low FICO scores (i.e. FICO scores below a certain threshold) while the other dots show customers having higher FICO scores (i.e. FICO scores above a certain threshold). Given the dots, the model defines the outlines of the dark gray areas. The dark grey areas can thereafter be used to predict that other customers falling within the outlined geographic will also have a low FIFO score, and therefore represent a higher risk than those customers outside of the gray outlined areas. A credit policy can be put in place to charge a higher rate of interest to those customers within the gray outlined areas, representing a higher risk and a lower rate of interest to those customers outside of the gray outlined areas, representing a lower risk. Other examples are described. For example, in another embodiment the models could be used to identify areas with higher or lower purchasing volume and could be used to inform policy changes in credit limits. In yet another embodiment, the models could also be used to define areas with higher attrition, which could be targeted for retention offers, or other marketing materials. In yet another embodiment, areas with higher or lower living costs could be used to adjust income requirements for credit policies.

In various embodiments, geospatial boundary optimization system 300 may comprise or implement multiple components or modules. As used herein the terms “component” and “module” are intended to refer to computer-related entities, comprising either hardware, a combination of hardware and software, software, or software in execution. For example, a component and/or module can be implemented as a process running on a processor, a hard disk drive, multiple storage drives (of optical, magnetic storage and/or any other type of storage medium), an object, an executable, a thread of execution, a program, and/or a computer. By way of illustration, both an application running on a server and the server can be a component and/or module. One or more components and/or modules can reside within a process and/or thread of execution, and a component and/or module can be localized on one computer and/or distributed between two or more computers as desired for a given implementa-tion. The embodiments are not limited in this context.

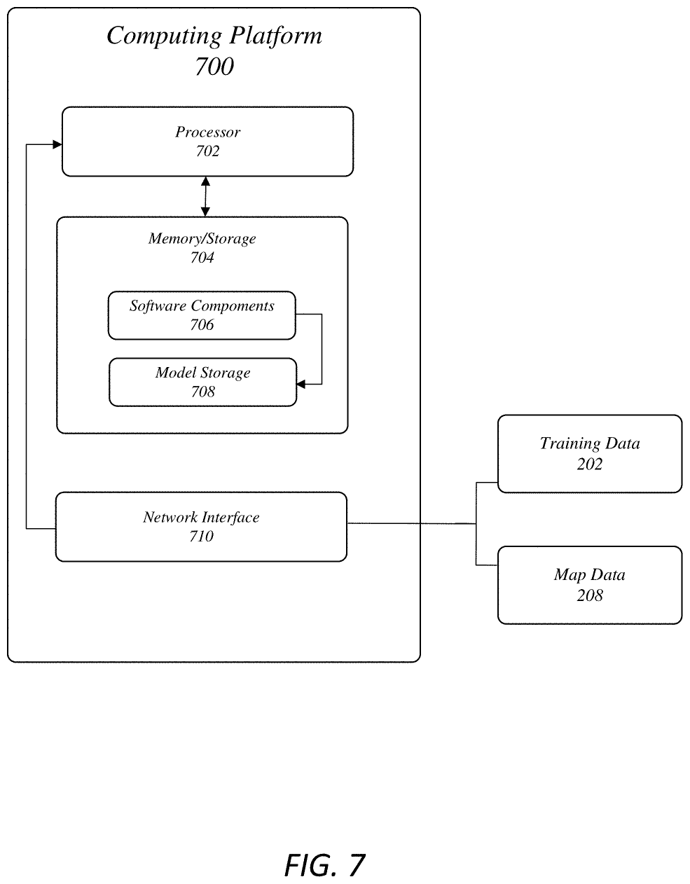

FIG. 7 shows an exemplary computing platform 700 upon which the claimed embodiments may be implemented. The computing platform 700 may provide computing functionality for the geospatial boundary optimization system 300. As shown, the computing platform 700 may include a processor 702. The geospatial boundary optimization system 300 may execute processing operations or logic using the processor 702. Processor 702 may be in communication with memory/storage 704. The processor 702 and the memory/storage 704 may comprise various hardware elements, software elements, or a combination of both. Processor 702 may be comprised of one or more processors. Examples of hardware elements may include devices, logic devices, components, processors, microprocessors, circuits, processor circuits, circuit elements, integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include data, models, software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Software components 706, stored in memory/storage 704 may include, but are not limited to, model training component 310 for training models, grid component 312 for defining a grid over the geographic area, grid scoring component 314 for scoring each cell in the grid, and edge-finding component 316 for defining the edge of the optimized geographic areas, or any combination thereof. Memory/storage component 704 may also include software components 7064 determining whether a new data point is within the optimized geographical area generated by the model. Memory/storage component 704 may also include storage for generated models 708. In some embodiments, computing platform 700 may include network interface 710 for interfacing with network data storage containing training data 302 and/or map data 308. In other embodiments, training data 302 and map data 308 may be available locally.

It should be realized by one of skill in the art that, although the invention has been explained in terms of a financial institution, the systems and methods may be used in any industry to define geographic areas based on any variable of interest, given the proper training data for the model.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art and it is understood that it is not intended to limit the scope of the invention.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as calculating or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise one or more general-purpose computers as selectively activated or reconfigured by a computer program stored in the computer. The procedures presented herein are not inherently related to a particular computer or other apparatus. Various general-purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively.

What has been described above includes examples of the disclosed arrangement of components. It is, of course, not possible to describe every conceivable combination of components and/or methodologies, but one of ordinary skill in the art may recognize that many further combinations and permutations are possible in various implementations of the invention. Accordingly, the novel arrangement of components is intended to embrace all such alterations, modifications, and variations that fall within the spirit and scope of the appended claims.

1. A system comprising:
a processor;
memory, in communication with the processor, the memory containing instructions that, when executed, cause the processor to:
identify exiting customers residing within a geographic area of interest;
train a machine-trained model using a data set comprising event tuples having a variable of interest comprising a discrete event or a condition regarding the identified existing customers and a geographic location of the identified exiting customers from the geographic area of interest to predict the variable of interest based on an input of a geographic location within the geographic area of interest;
superimpose a grid over an image of the geographic area of interest;
predict the value of the variable of interest for each cell in the grid using the machine-trained model, each cell in the grid defined by one or more edges;
find one or more contoured geographic areas within the geographical area of interest by applying an image-based edge-finding algorithm to the image of the geographic area of interest, the contour of the contoured geographic areas based on the a comparison between desired values of the variable of interest and the predicted values of the variable of interest for each cell in the grid, the contours of the contoured geographic areas independent of the edges of the cells in the grid;
and
implement a geospatial strategy for interaction with all identified existing customers within the one or more contoured geographic areas.

2. The system of claim 1 wherein the grid resolution is larger than the distribution of data used to train the model.

3. The system of claim 1 wherein obtaining the value of the variable of interest for each cell in the grid comprises using the geographic center of the grid as the input to the trained model.

4. The system of claim 1 wherein obtaining the value of the variable of interest for each cell in the grid comprises further instructions that cause the processor to:
evaluate the trained model using the geographic locations of grid intersections defining the corners of the cell to obtain a value for the variable of interest at each corner location; and
average the values of the variable of interest at each corner location to obtain a value of the variable of interest for the cell.

5. The system of claim 1 wherein the value of the variable of interest for each cell is a probability.

6. The system of claim 1 wherein the value of the variable of interest for each cell is a binary value.

7. (canceled)

8. The system of claim 1 comprising further instructions that cause the processor to:
use an address associated with the customer as the geographic location of the customer;
determine if the geographic location of the customer is within one of the one of more contoured geographic areas.

9. The system of claim 1 wherein the geospatial strategy comprises adjusting the interest rate charged to a customer or the credit limit of the customer based solely on the customer being within one of the one or more contoured geographic areas.

10. (canceled)

11. The system of claim 1 wherein the geospatial strategy comprises adjusting a marketing message delivered to the customer based solely on the customer being within one of the one or more contoured geographic areas.

12. (canceled)

13. The system of claim 1 wherein the training data includes only geo-demographic data having a geographic component in the geographic area of interest.

14. The system of claim 1 wherein the training data is based on a history of interactions with the customer.

15. The system of claim 13 wherein the geo-demographic data is selected from a group consisting of average income in the geographic area of interest, average net worth in the geographic area of interest, default rates in the geographic area of interest, employment rates in the geographic area of interest, average credit risk scores in the geographic area of interest, FICO scores of the customers included in the training data, payment history of customers in the geographic area of interest and proximity to an event of interest in the geographic area of interest.

16. (canceled)

17. The system of claim 5 wherein the variable of interest is the likelihood of default in repayment of a credit card debt or loan.

18. (canceled)

19. The system of claim 2 wherein the size of the cells in the grid of cells is chosen such that a majority of the cells include geographic locations associated with customer data used to train the model.

20. (canceled)

21. (canceled)
